(19) United States
(12) Patent Application Publication
(10) Pub. No.: US 2024/0161112 A1
(43) Pub. Date: May 16, 2024

(54) LARGE-SCALE ALARM DEPLOYMENT METHODS, APPARATUSES, AND DEVICES

(71) Applicant: Alipay (Hangzhou) Information Technology Co., Ltd., Hangzhou (CN)

(72) Inventors: Zhengdong Gao, Hangzhou (CN); Guiqiang Xu, Hangzhou (CN); Jian Xu, Hangzhou (CN); Zhihui Jiao, Hangzhou (CN)

(73) Assignee: Alipay (Hangzhou) Information Technology Co., Ltd., Hangzhou (CN)

(21) Appl. No.: 18/509,193

(22) Filed: Nov. 14, 2023

(30) Foreign Application Priority Data
Nov. 15, 2022 (CN) 202211425605.6

(51) Int. Cl. G06Q 20/40; G06Q 20/38

(52) U.S. Cl. CPC G06Q 20/401; G06Q 20/389

(57) ABSTRACT

Embodiments of this specification disclose large-scale alarm deployment computer-implemented methods, systems, apparatuses, devices, and computer-readable media. In an example, whether an indicator in a large-scale indicator set is a non-long-tail indicator or a long-tail indicator is determined. For the non-long-tail indicator, a first task is scheduled for traffic data of the non-long-tail indicator by using a first time interval, and alarm calculation is performed by executing the first task. For the long-tail indicator, aggregation processing is performed on traffic data of the long-tail indicator, a second task is scheduled for correspondingly obtained aggregated data by using a second time interval longer than the first time interval, and alarm calculation is performed by executing the second task.

### CROSS-REFERENCE TO RELATED APPLICATIONS

This application claims priority to Chinese Patent Application No. 202211425605.6, filed on Nov. 15, 2022, which is hereby incorporated by reference in its entirety.

### TECHNICAL FIELD

This specification relates to the field of security monitoring technologies, and in particular, to large-scale alarm deployment methods, apparatuses, and devices.

### BACKGROUND

With development of Internet technologies and widespread use of mobile terminals, most services can be performed online based on mobile applications.

For some large and medium-sized applications or companies, there are a massive quantity of services in ecology that the applications or companies are applied to, and a massive quantity of indicators need to be monitored to detect abnormality and alarms in a timely way. The indicators here can be understood as objects or parameters in a certain dimension, for example, a massive quantity of merchants, a massive quantity of applications, a massive quantity of applets, or a massive quantity of products. A quantity of indicators is very large, and there may even be tens of millions of indicators (for example, tens of millions of merchants). On conventional monitoring platforms, data collection to alarm notification usually share the same process. Therefore, storage and calculation resources consumed are huge, and alarm noise is loud. As a result, it is difficult to accurately and comprehensively hit crucial risk points.

Based on the above, a better alarm deployment solution for large-scale indicators is needed.

### SUMMARY

One or more embodiments of this specification provide large-scale alarm deployment methods, apparatuses, and devices and storage mediums, to solve the following technical problem of needing a better alarm deployment solution for large-scale indicators.

To solve the above-mentioned technical problem, one or more embodiments of this specification are implemented as follows:

One or more embodiments of this specification provide a large-scale alarm deployment method, including the following: determining whether an indicator in a large-scale indicator set is a non-long-tail indicator or a long-tail indicator; for the non-long-tail indicator, scheduling a task for traffic of the non-long-tail indicator by using a first time interval, and performing alarm calculation by executing the task; and for the long-tail indicator, performing aggregation processing on traffic of the long-tail indicator, scheduling a task for correspondingly obtained aggregated data by using a second time interval longer than the first time interval, and performing alarm calculation by executing the task.

One or more embodiments of this specification provide a large-scale alarm deployment apparatus, including: a long tail distinguishing module, configured to determine whether an indicator in a large-scale indicator set is a non-long-tail indicator or a long-tail indicator; a non-long tail processing module, configured to: for the non-long-tail indicator, schedule a task for traffic of the non-long-tail indicator by using a first time interval, and perform alarm calculation by executing the task; and a long tail processing module, configured to: for the long-tail indicator, perform aggregation processing on traffic of the long-tail indicator, schedule a task for correspondingly obtained aggregated data by using a second time interval longer than the first time interval, and perform alarm calculation by executing the task.

One or more embodiments of this specification provide a large-scale alarm deployment device, including: at least one processor; and a memory communicatively connected to the at least one processor, where the memory stores instructions that can be executed by the at least one processor, and the instructions are executed by the at least one processor, so that the at least one processor can: determine whether an indicator in a large-scale indicator set is a non-long-tail indicator or a long-tail indicator; for the non-long-tail indicator, schedule a task for traffic of the non-long-tail indicator by using a first time interval, and perform alarm calculation by executing the task; and for the long-tail indicator, perform aggregation processing on traffic of the long-tail indicator, schedule a task for correspondingly obtained aggregated data by using a second time interval longer than the first time interval, and perform alarm calculation by executing the task.

One or more embodiments of this specification provide a non-volatile computer storage medium. The non-volatile computer storage medium stores computer executable instructions, and the computer executable instructions are set as follows: determining whether an indicator in a large-scale indicator set is a non-long-tail indicator or a long-tail indicator; for the non-long-tail indicator, scheduling a task for traffic of the non-long-tail indicator by using a first time interval, and performing alarm calculation by executing the task; for the long-tail indicator, performing aggregation processing on traffic of the long-tail indicator, scheduling a task for correspondingly obtained aggregated data by using a second time interval longer than the first time interval, and performing alarm calculation by executing the task.

The above-mentioned at least one technical solution used in the one or more embodiments of this specification can achieve the following beneficial effects: In the large-scale indicator set, a small quantity of indicators with high-frequency traffic are distinguished from a large quantity of indicators with low-frequency traffic, so that a long-tail indicator that was difficult to accurately monitor in the past is effectively identified. For traffic of the long-tail indicator (referred to as long-tail traffic), considering that total traffic accumulated by the long-tail traffic cannot be ignored, but the traffic is very sparse in a time sequence, a relatively long time interval is used to perform aggregation processing and alarm calculation. Therefore, risk points that were easy to ignore in the past can be covered more accurately and comprehensively, and traffic data storage pressure can also be reduced. For non-long-tail traffic, a relatively short time interval is used to perform alarm calculation on the non-long-tail traffic. As such, in the above-mentioned grading processing of the long-tail traffic and the non-long-tail traffic, an alarm deployment capability is more refined, and processing resources are actually put to the best use while large-scale indicators are comprehensively considered, so that service risks and monitoring costs can be effectively reduced.

### BRIEF DESCRIPTION OF DRAWINGS

To describe the technical solutions in the embodiments of this specification or in the existing technology more clearly, the following briefly describes the accompanying drawings needed for describing the embodiments or the existing technology. Clearly, the accompanying drawings in the following descriptions merely show some embodiments of this specification, and a person of ordinary skill in the art can still derive other drawings from these accompanying drawings without creative efforts.

FIG. 1 is a schematic flowchart illustrating a large-scale alarm deployment method, according to one or more embodiments of this specification;

FIG. 2 is a schematic diagram illustrating an implementation solution of the method of FIG. 1 in an actual application scenario, according to one or more embodiments of this specification;

FIG. 3 is a schematic diagram illustrating dynamic refreshing of a merchant class, according to one or more embodiments of this specification;

FIG. 4 is a time sequence diagram illustrating a process involved in the solution in FIG. 2, according to one or more embodiments of this specification;

FIG. 5 is a schematic diagram illustrating a structure of a large-scale alarm deployment apparatus, according to one or more embodiments of this specification; and

FIG. 6 is a schematic diagram illustrating a structure of a large-scale alarm deployment device, according to one or more embodiments of this specification.

### DESCRIPTION OF EMBODIMENTS

Embodiments of this specification provide large-scale alarm deployment methods, apparatuses, and devices and storage mediums.

To make a person skilled in the art better understand the technical solutions in this specification, the following clearly and comprehensively describes the technical solutions in the embodiments of this specification with reference to the accompanying drawings in the embodiments of this specification. Clearly, the described embodiments are merely some but not all of the embodiments of this application. All other embodiments obtained by a person of ordinary skill in the art based on the embodiments of this specification without creative efforts shall fall within the protection scope of this application.

As mentioned in the background, on conventional monitoring platforms, data collection to alarm notification usually share the same process. However, in actual scenarios, there is a huge difference between indicators at a priority level and a data level. Therefore, conventional monitoring methods may cause a series of specific problems such as excessive resource consumption, untimely detection of core service alarms, and relatively loud noise of non-core service alarms. Especially in a scenario with a massive quantity of indicators, these problems become more prominent, which makes it difficult to deploy alarms truly and effectively. Based on the above, this application is mainly intended to enable all core and non-core services to have monitoring and emergency capabilities for the scenario with a massive quantity of indicators from a perspective of indicators.

Based on actual service data experience and statistical theory, it is found that there are a huge quantity of rarely needed indicators in the scenario with a massive quantity of indicators, which is one of root causes of the above-mentioned consumption problem, namely, long-tail traffic.

An example that indicators are merchants is used for analysis. If there are a massive quantity of merchants on an e-commerce platform, traffic of the massive quantity of merchants needs to be monitored, so that alarming and emergency handling can be performed when the traffic is abnormal. Transaction service data of a corresponding merchant can be selected as a monitoring object of the traffic. In a transaction link of merchants, monitoring and alarming are performed on all merchants by a platform party from a common monitoring perspective. Therefore, it can be observed from a global perspective whether the whole transaction link is faulty, but in practice, most traffic or large chunks of centralized traffic is contributed by a relatively small quantity of core merchants (for example, more than 1,000 large and medium-sized customers) in a total quantity of merchants, while remaining traffic is contributed by a large quantity of non-core customers (for example, millions or even tens of millions of small merchants). Traffic generated by one of these non-core merchants is very small and has a low frequency, and therefore, is distributed widely and sparsely. In the embodiments of this application, such traffic is referred to as long-tail traffic. A large quantity of resources need to be consumed to perform monitoring and alarming on the long-tail traffic. In addition, when a problem occurs in the long-tail traffic, it is very difficult to detect the problem, and therefore, timely alarming and emergency stop-loss processing cannot be performed.

To ensure that non-core indicators corresponding to the long-tail traffic also have relatively good monitoring and alarming capabilities while core indicators corresponding to non-long-tail traffic can be effectively monitored and excessive resource consumption and traffic overload can be avoided, indicators corresponding to the long-tail traffic and the non-long-tail traffic are distinguished based on data features. In some embodiments, a huge quantity of long-tail indicators that constitute a massive quantity of indicators are optionally graded. Monitoring data are routed to a targeted execution policy based on a grading result. In terms of time intervals and aggregation granularities, alarm calculation task scheduling is differentiated between indicators of different levels and traffic of the indicators. The following continues to provide detailed descriptions based on this idea.

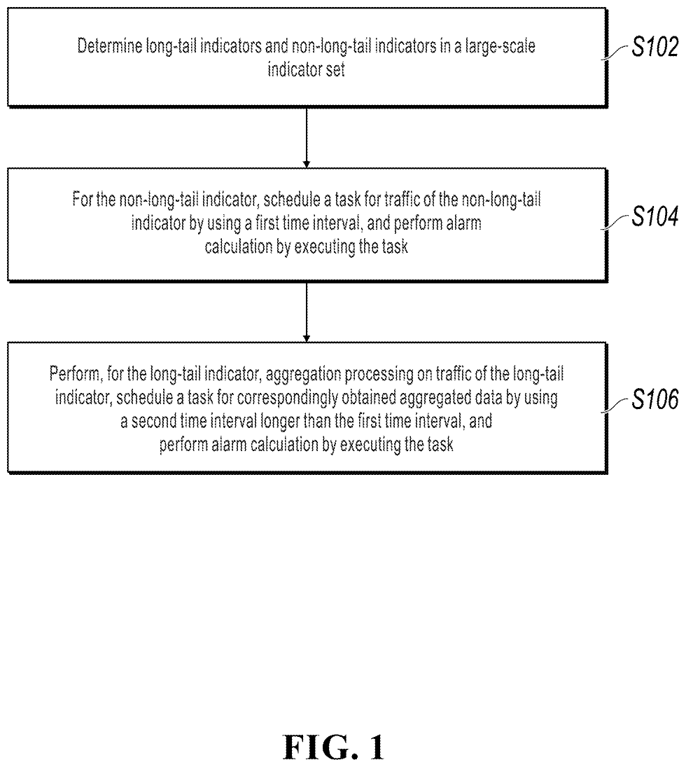

FIG. 1 is a schematic flowchart illustrating a large-scale alarm deployment method, according to one or more embodiments of this specification. The method can be applied to different service fields. For example, these service fields include an e-commerce service field, an e-payment service field, a social service field, a game service field, and a public service field. This process can be performed on risk control related devices of platform parties in these fields. Some input parameters or intermediate results in the process can be manually intervened with to improve accuracy.

The process in FIG. 1 includes the following steps:
S102: Determine long-tail indicators and non-long-tail indicators in a large-scale indicator set.

In one or more embodiments of this specification, the long-tail indicators are characterized by a large quantity and a large proportion in the large-scale indicator set and low-frequency individual traffic, namely, a large quantity of indicators with low-frequency traffic. On the contrary, the non-long-tail indicators are small in quantity and proportion in the large-scale indicator set, and have high-frequency individual traffic, namely, a small quantity of indicators with high-frequency traffic.

A merchant indicator is used as an example. For a merchant, traffic of the merchant is, for example, transaction service data, and includes transactions with a time sequence. The long-tail indicators can be specifically a large quantity of merchants with low-frequency transactions, namely, long-tail merchants, and the non-long-tail indicators are a small quantity of merchants with high-frequency transactions, namely, non-long-tail merchants.

Then an applet indicator is used as an example. Traffic of the applet indicator is, for example, click access data. Correspondingly, a large quantity of applets with low-frequency click access can be distinguished as long-tail applets, and a small quantity of applets with high-frequency click access can be distinguished as non-long-tail applets.

Then a performance parameter indicator is used as an example. Traffic of the performance parameter indicator is, for example, collected performance parameter performance data. Correspondingly, a large quantity of performance parameters with low-frequency performance (for example, an overload count and a memory overflow count) and a small quantity of performance parameters with high-frequency performance (for example, a real-time transmission rate and a CPU occupation ratio) can be distinguished.

It is worthwhile to note that the low-frequency traffic and the high-frequency traffic are relative concepts. Whether traffic is low-frequency traffic or high-frequency traffic needs to be determined with reference to a quantity in the large-scale indicator set. Most indicators or a majority of indicators with low-frequency traffic in the large-scale indicator set can be classified as long-tail indicators, so that long-tail traffic in a real sense can be identified, and further, advantages of the solution can be fully utilized.

In one or more embodiments of this specification, a period can be set to adjust the long-tail indicators and the non-long-tail indicators. For example, a proportion is specified, and every time the adjustment period is reached, reclassification is automatically triggered for long-tail indicators and non-long-tail indicators in the large-scale indicator set based on the proportion and latest statuses of traffic frequencies of the indicators.

In one or more embodiments of this specification, the long-tail indicators and the non-long-tail indicators can be manually adjusted. For example, in practice, a frequency of traffic of a certain indicator is relatively high but the traffic is irregular and uneven, for example, the traffic is embodied as a pulse form with a high peak value. In this case, to more comprehensively monitor the indicator, the indicator can be manually determined as a long-tail indicator.

In one or more embodiments of this specification, each of the above-mentioned two types of indicators obtained through classification can be further classified based on actual needs.

The non-long-tail indicators are used as an example. For example, the non-long-tail indicators are further classified into indicators with higher-frequency traffic and indicators with relatively-high-frequency traffic based on high-frequency degrees of traffic.

However, for the long-tail indicators, because a quantity of such indicators is large, a situation is more complex, and heterogeneity between the indicators may be more prominent, further classification does not need or mainly need to be performed based on high-frequency degrees of traffic. Taking merchants as an example, for example, the merchants can be further classified based on various features in consideration of features such as regions, product types, target customers, and positions in an industry chain, so that categories obtained through further classification are more homogeneous.

S104: For the non-long-tail indicator, schedule a task for traffic of the non-long-tail indicator by using a first time interval, and perform alarm calculation by executing the task.

In one or more embodiments of this specification, tasks are scheduled for long-tail traffic and non-long-tail traffic by using differentiated time intervals. The tasks here include at least alarm calculation, and can further include corresponding traffic collection and preprocessing.

Traffic of the non-long-tail indicator is non-long-tail traffic, and usually is core traffic and is more important. Therefore, a scheduling period can be shortened, and scheduling is performed at a relatively short time interval. For example, second-level traffic detail data are collected, and second-level scheduling is performed. If the non-long-tail indicators are further classified, the first time interval can also be further classified accordingly. For example, second- level scheduling is used for indicators with higher-frequency traffic, and minute-level scheduling is used for indicators with relatively-high-frequency traffic.

S106: For the long-tail indicator, perform aggregation processing on traffic of the long-tail indicator, schedule a task for correspondingly obtained aggregated data by using a second time interval longer than the first time interval, and perform alarm calculation by executing the task.

A quantity of long-tail indicators is huge, which is not conducive to accurate monitoring or effective storage and query. Assume that the long-tail indicators are processed by using a same standard as the non-long-tail indicators. For example, minute-level or even second-level collection and storage are performed. In this case, at least two problems occur: First, there are no valid data in most of the time, and therefore monitoring is of no practical significance. Second, sparse traffic data of individuals tend to cause inefficiency and improperness of a storage structure and cause great pressure to storage when there are tens of millions of such individuals.

Based on the above, compared with the non-long-tail indicator, a scheduling period is prolonged and a longer time interval is used for scheduling. For example, at least minute-level scheduling is performed, or even hour-level scheduling or scheduling at a longer-time level can be performed as needed. In addition, aggregation processing is performed on traffic of the long-tail indicator. For example, statistical combination or nonlinear feature fusion is performed on a plurality of transactions in a specified time interval (for example, a time interval that is not longer than the second time interval), to aggregate the plurality of transactions into one transaction, so that sparse traffic is more centralized, and alarm calculation is performed more pertinently, thereby reducing a quantity of task scheduling times and improve efficiency of each time of task scheduling.

If necessary, aggregation can also be applied to some non-long-tail traffic. For example, minute-level aggregation processing is performed for indicators with relatively-high-frequency traffic. It is worthwhile to note that the two are still different. For non-long-tail traffic, assuming that aggregation processing needs to be performed, online aggregation can be used. For example, non-linear high-dimensional feature fusion is performed on a plurality of transactions based on an online machine learning model, to remap the plurality of transactions to one transaction. For long-tail traffic, an offline aggregation method using lower costs and a lower real-time requirement can be considered. For example, aggregation processing is performed through offline archiving, which is more consistent with long-tail features of small traffic and wide distribution.

In the method of FIG. 1, in the large-scale indicator set, a small quantity of indicators with high-frequency traffic are distinguished from a large quantity of indicators with low-frequency traffic, so that a long-tail indicator that was difficult to accurately monitor in the past is effectively identified. For traffic of the long-tail indicator (referred to as long-tail traffic), considering that total traffic accumulated by the long-tail traffic cannot be ignored, but the traffic is very sparse in a time sequence, a relatively long time interval is used to perform aggregation processing and alarm calculation. Therefore, risk points that were easy to ignore in the past can be covered more accurately and comprehensively, and traffic data storage pressure can also be reduced. For non-long-tail traffic, a relatively short time interval is used to perform alarm calculation on the non-long-tail traffic. As such, in the above-mentioned grading processing of the long-tail traffic and the non-long-tail traffic, an alarm deployment capability is more refined, and processing resources are actually put to the best use while large-scale indicators are comprehensively considered, so that service risks and monitoring costs can be effectively reduced.

Based on the method of FIG. 1, this specification further provides some specific implementation solutions and extension solutions of the method. For a more intuitive understanding, the following mainly continues to provide descriptions based on a merchant scenario.

In one or more embodiments of this specification, as mentioned above, heterogeneity of the long-tail traffic is more prominent. Therefore, in addition to performing advanced classification to distinguish the long-tail traffic from the non-long-tail traffic, in particular, the long-tail traffic can be further deepened, to focus on deeper reclassification of the long-tail traffic.

For example, second time intervals (for example, at a minute level or an hour level) of a plurality of different levels that are longer than the first time interval (for example, at least longer than second level) are determined. For the current long-tail merchant or a current moment, a second time interval in the second time intervals of the plurality of different levels to which the current long-tail merchant or the current moment corresponds is determined as a dynamic time interval; and aggregation processing is performed on transaction service data of the current long-tail merchant and/or a long-tail merchant associated with the current long-tail merchant (for example, a part of long-tail traffic that's not yet processed in a previous period) by using the dynamic time interval, and a task is scheduled for correspondingly obtained aggregated data.

“Dynamic” here can include being dynamic in a dimension of a merchant status. For example, long-tail users of a plurality of different levels are obtained through classification based on low-frequency degrees of transactions or importance of long-tail merchants. A longer second time interval is used for a long-tail merchant who has a low frequency or is more important. “Dynamic” can also include being dynamic in a dimension of a moment status. For example, a shorter second time interval is dynamically used when the non-long-tail traffic is moderate, a shorter second time interval is dynamically used when an abnormality reporting amount of the long-tail merchant increases, and a longer second time interval is used in service peak hours. The dynamic setting of the second time interval can be intelligently and adaptively performed to strike a balance between fully and effectively utilizing resources and better serving long-tailed merchants.

Similarly, simpler classification can be further performed for the non-long-tail traffic. For example, when it is determined that an indicator in the large-scale indicator set is a non-long-tail indicator, at least two types of non-long-tail merchants obtained through classification based on different high-frequency degrees of transactions are determined. The first time interval is negatively correlated with the different high-frequency degrees of transactions. A type that a merchant in the large-scale merchant set belongs to in the at least two types is determined, so that task scheduling is performed by using a corresponding first time interval (for example, at a second level or a minute level).

In one or more embodiments of this specification, when alarm calculation is performed through task scheduling, non-long-tail traffic is more homogeneous. To improve calculation efficiency, a uniform rule threshold can be set without distinguishing between different merchants, and a corresponding rule threshold detection process is triggered to perform alarm calculation. This method is direct and efficient, and avoids a complex calculation process.

However, for long-tail traffic, especially sparse and less regular traffic, applicability of the uniform rule threshold is reduced, and it is difficult to set a reliable rule threshold used for direct comparison. Therefore, an alarm can be triggered more adaptively and reliably based on a machine learning model through high-latitude feature mapping and mining and intelligent algorithm detection. Details are as follows: It can be determined whether the above-mentioned dynamic time interval is long enough. If yes, and an industry feature and/or historical data of corresponding transaction service data can be obtained (for example, model training is performed by using the data in advance, or more timely small-sample learning is performed for the current long-tail merchant to fine-tune the model), an intelligent algorithm detection process is triggered based on the industry feature and/or the historical data, to perform alarm calculation; otherwise, a rule threshold detection process can be triggered to perform alarm calculation.

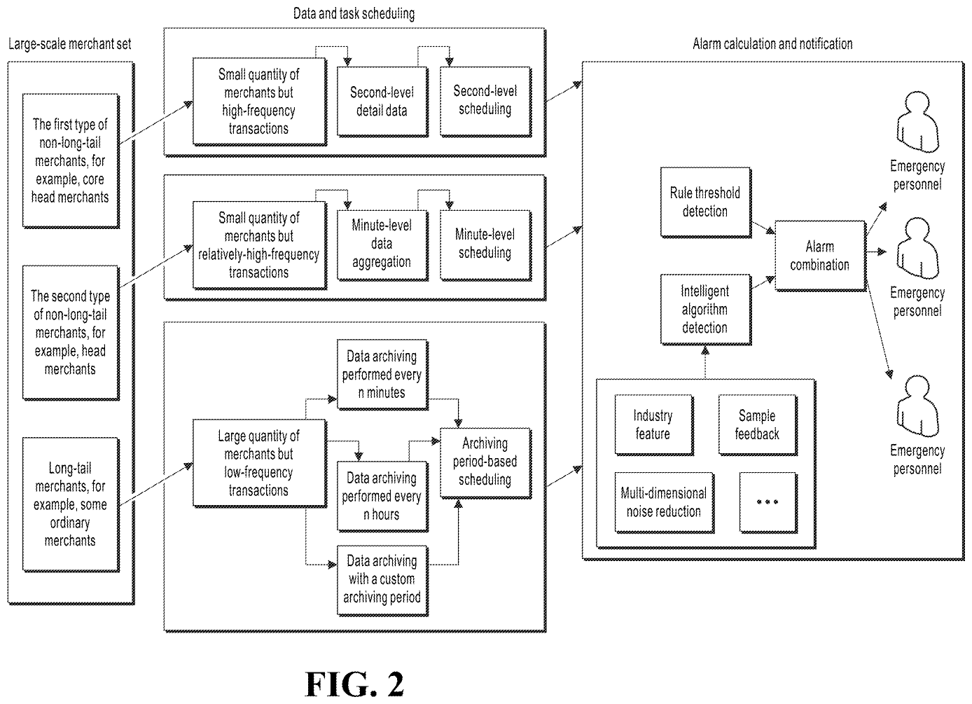

Based on the above-mentioned descriptions, one or more embodiments of this specification further provide a schematic diagram illustrating an implementation solution of the method of FIG. 1 in an actual application scenario, as shown in FIG. 2.

In this scenario, a large-scale merchant set is first divided into three types of merchants based on merchant features (for example, transaction volumes or transaction frequencies): the most important first type of non-long-tail merchants, for example, a small quantity of some core head merchants with high-frequency transactions; the second most important second type of non-long-tail merchants, for example, a small quantity of some head merchants with relatively-high-frequency transactions; and long-tail merchants, for example, a large quantity of some ordinary merchants with low-frequency transactions.

Refined transaction service data collection and aggregation methods are used for different types of merchants. For example, for the core head merchant, monitoring data are second-level detail data, for the head merchant, monitoring data are minute-level data, and for the ordinary merchant, monitoring data can be data of above a minute level. For transaction service data of the ordinary user, because traffic is small and is widely distributed, aggregation processing can be performed through archiving (for example, offline archiving). For transaction service data of the head merchant, more timely online aggregation processing can also be performed.

A time interval corresponding to the ordinary merchant is more flexible. The time interval can be at a minute level (for example, archiving processing is performed on data every n minutes) or an hour level (for example, archiving processing is performed on data every n hours), or can be another custom archiving period, etc. It is worthwhile to note that because a quantity of ordinary merchants is very large, the ordinary merchants can be first classified before being dynamically adjusted. In this case, at a same moment, an ordinary merchant corresponding to a minute level, an ordinary merchant corresponding to an hour level, and an ordinary merchant corresponding to another custom level may all exist. This multi-layered dynamic grading method for long-tail merchants can give enough but not excessive attention to different long-tail merchants in terms of both intensity and a granularity in a more complete and more refined way, to fully mine hidden risk points in long-tail traffic.

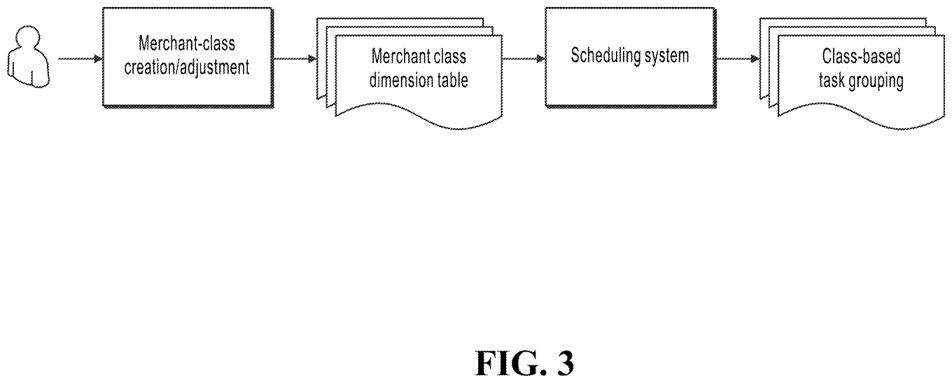

To better perform differentiated processing on merchants in better compliance with facts, a merchant class dimension table is generated and maintained, and a corresponding class is used to dynamically represent a category that a merchant currently belongs to, so that current category information is fresh and reliable. References can be made to FIG. 3. FIG. 3 is a schematic diagram illustrating dynamic refreshing of a merchant class, according to one or more embodiments of this specification.

In FIG. 3, a corresponding merchant class maintenance page can be provided, and a merchant-class creation or adjustment operation can be performed on the page based on a classification result. A platform can generate and maintain a merchant class dimension table, used to dynamically record and update an operation result. In addition to a merchant class that represents a corresponding category, the operation result can also include a time interval that corresponds to the class and is used to perform task scheduling. The time interval varies with the merchant class.

A scheduling system performs refined grouping scheduling based on information such as classes and time intervals recorded in the merchant class dimension table. Monitoring and detection tasks of different frequencies are generated for different classes, so that specific alarm calculation can be performed.

Based on the above, FIG. 2 is further described. Different classes of merchants can have different data collection and detection task scheduling periods. The above-mentioned time interval is duration of one period. The data collection period and the detection task scheduling period can adapt to each other, for example, can be consistent to the greatest extent, so that the operations can be connected more smoothly. As such, detection task scheduling can be performed by using the data collection period. For example, for a core head merchant, if the data collection period is at a second level, detection task scheduling can also be performed at a second level.

Data collection and periodic detection task scheduling are performed based on a time interval corresponding to a merchant class. At least for transaction service data of an ordinary user, after the data are collected based on the time interval, aggregation processing is further performed, and correspondingly obtained aggregated data are stored. Then corresponding aggregated data are obtained through query according to the time interval based on an aggregation moment (data before the aggregation correspond to a plurality of different moments, one moment is used after the aggregation, and the moment is referred to as the aggregation moment) corresponding to the aggregation processing, to schedule a task accordingly, so that storage and query pressure can be effectively reduced.

When alarm calculation is specifically performed after a detection task is triggered, rule threshold detection and intelligent algorithm detection are supported. For example, the former determines whether an alarm is needed by using a given threshold and operator, and the latter determines whether an abnormality exists by using historical data and an industry feature. As mentioned above, in particular, a detection method can be adaptively selected for long-tail traffic.

To improve efficiency, alarm combination is actively performed during alarm calculation, to avoid ignoring crucial risks due to excessively loud alarm noise. Details are as follows: It is detected whether transaction service data are abnormal based on a specified monitoring item, and if yes, a corresponding abnormality event is generated, and alarm combination is performed on a plurality of abnormality events belonging to a same monitoring item, to send an alarm notification to related emergency personnel. Therefore, the emergency personnel may previously be subject to a plurality of alarms with similar attributions or performance, and can receive only one alarm after the combination.

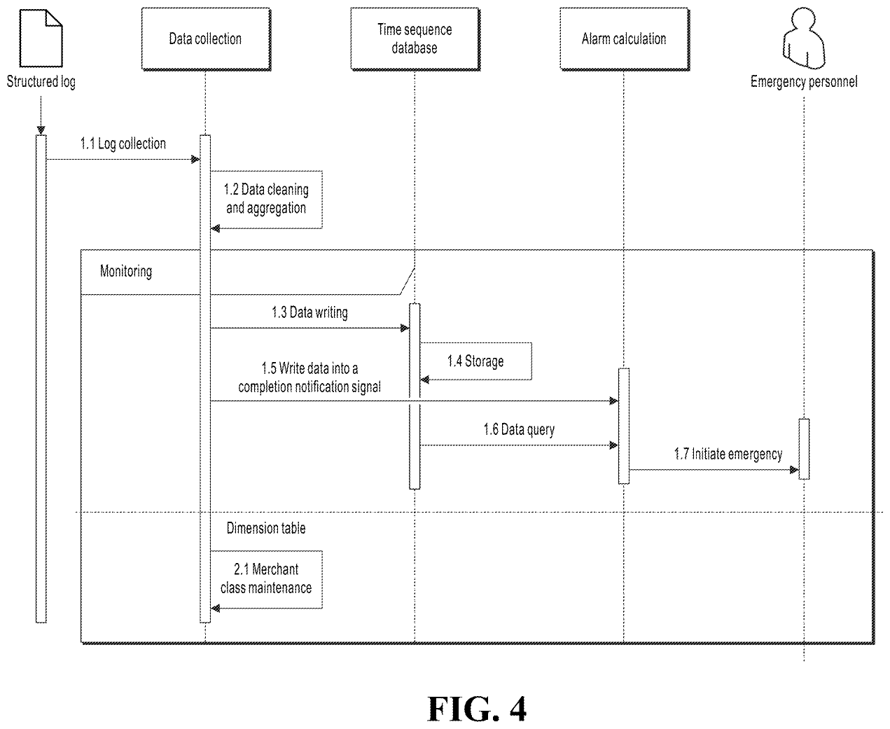

Further, in the merchant scenario, a time sequence and timeliness are particularly important. Therefore, for data collection and detection in a monitoring process, one or more embodiments of this specification further provide a time sequence diagram involved in the solution in FIG. 2, as shown in FIG. 4.

A process in FIG. 4 includes the following steps:

A data collection service (or module) records a structured log reflecting transaction service data by using a system, performs collection and cleaning, and generates corresponding time sequence data. If the data need to be aggregated, the data are aggregated based on a corresponding merchant class. Then aggregated data can be used for monitoring or other service processes.

In a monitoring process, the time sequence data are stored in a time sequence database, and the data are written into a completion notification signal and sent to an alarm calculation service.

The alarm calculation service detects an alarm configuration of a user and related time sequence data.

If an alarm triggering condition is satisfied, an emergency process is initiated, and emergency personnel are called.

Certainly, the monitoring process can further optionally include a maintenance process of a merchant class dimension table.

Based on the above-mentioned solutions, accurate monitoring and alarm deployment can be truly implemented for all of a massive quantity of indicators, and especially in the merchant scenario, risks can be eliminated for a massive quantity of small merchants in a timely way, so that robustness of the entire platform and user experience are improved.

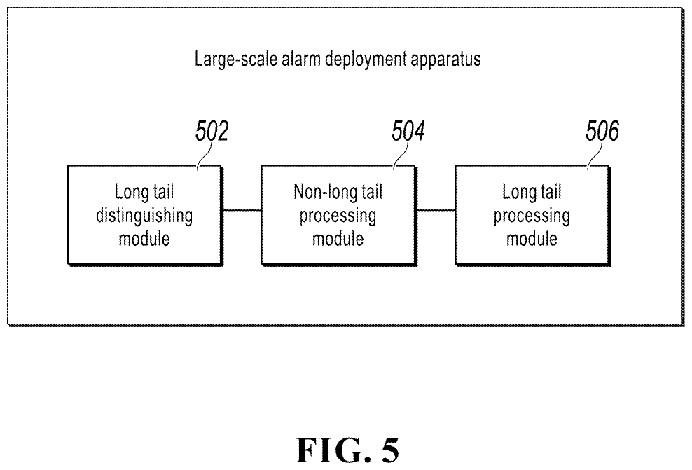

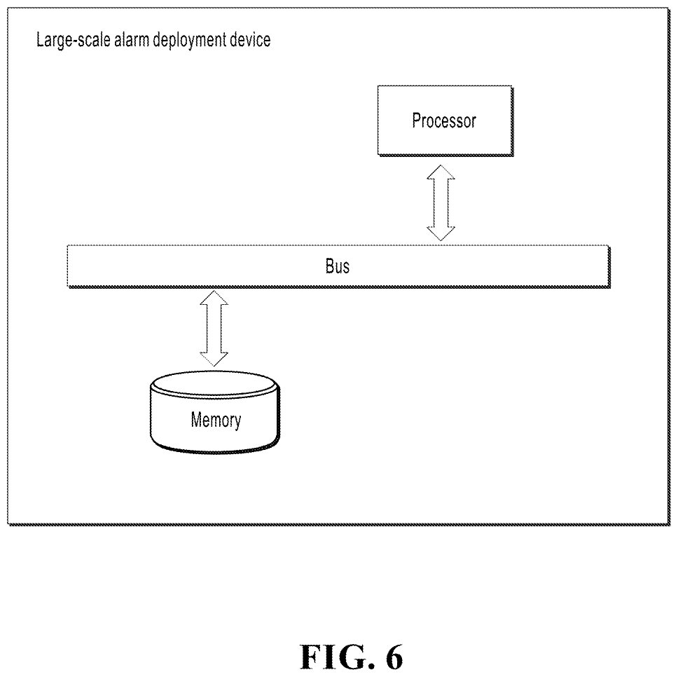

Based on the same idea, one or more embodiments of this specification further provide apparatuses and devices corresponding to the above-mentioned methods, as shown in FIG. 5 and FIG. 6. The apparatuses and the devices can correspondingly perform the above-mentioned methods and related optional solutions.

FIG. 5 is a schematic diagram illustrating a structure of a large-scale alarm deployment apparatus, according to one or more embodiments of this specification. The apparatus includes: a long tail distinguishing module 502, configured to determine whether an indicator in a large-scale indicator set is a non-long-tail indicator or a long-tail indicator; a non-long tail processing module 504, configured to: for the non-long-tail indicator, schedule a task for traffic of the non-long-tail indicator by using a first time interval, and perform alarm calculation by executing the task; and a long tail processing module 506, configured to: for the long-tail indicator, perform aggregation processing on traffic of the long-tail indicator, schedule a task for correspondingly obtained aggregated data by using a second time interval longer than the first time interval, and perform alarm calculation by executing the task.

Optionally, the indicator indicates a merchant, the non-long-tail indicator indicates a non-long-tail merchant, the long-tail indicator indicates a long-tail merchant, and the traffic includes transaction service data of a corresponding merchant.

Optionally, the long tail processing module 506 is configured to: determine second time intervals of a plurality of different levels that are longer than the first time interval; for the current long-tail merchant or a current moment, determine, as a dynamic time interval, a second time interval in the second time intervals of the plurality of different levels to which the current long-tail merchant or the current moment corresponds; and perform aggregation processing on transaction service data of the current long-tail merchant and/or a long-tail merchant associated with the current long-tail merchant by using the dynamic time interval, and schedule a task for correspondingly obtained aggregated data.

Optionally, the long tail processing module 506 is configured to: determine whether the dynamic time interval is long enough; and in response to determining that the dynamic time interval is long enough and that an industry feature and/or historical data of corresponding transaction service data are obtainable, trigger an intelligent algorithm detection process based on the industry feature and/or the historical data, to perform alarm calculation; or in response to determining that the dynamic time interval is not long enough, trigger a rule threshold detection process to perform alarm calculation.

Optionally, the long tail processing module 506 is configured to perform aggregation processing on transaction service data of the long-tail merchant through offline archiving; and the scheduling a task for traffic of the non-long-tail indicator specifically includes the following: performing online aggregation processing on transaction service data of the non-long-tail merchant to perform task scheduling.

Optionally, the apparatus further includes: a class updating module, configured to: before it is determined whether the indicator in the large-scale indicator set is a non-long-tail indicator or a long-tail indicator, generate and maintain a merchant class dimension table, and dynamically update a merchant class in the merchant class dimension table and a time interval that corresponds to the merchant class and that is used for task scheduling, where the merchant class reflects a time interval currently corresponding to a corresponding merchant, where the long tail processing module 506 is configured to: perform aggregation processing on transaction service data of a current corresponding merchant by using the time interval, and store correspondingly obtained aggregated data; and obtain, through query, the corresponding aggregated data according to the time interval based on an aggregation moment corresponding to the aggregation processing, and perform task scheduling accordingly.

Optionally, the long tail distinguishing module 502 is configured to determine at least two types of non-long-tail merchants obtained through classification based on different high-frequency degrees of transactions, where the first time interval is negatively correlated with the different high-frequency degrees of transactions; and determine a type that a merchant in the large-scale merchant set belongs to in the at least two types, to perform task scheduling by using the corresponding first time interval.

Optionally, the non-long tail processing module 504 or the long tail processing module 506 is configured to: detect whether the transaction service data are abnormal based on a specified monitoring item, and in response to detecting that the transaction service data are abnormal based on the specified monitoring item, generate a corresponding abnormality event; and perform alarm combination on a plurality of abnormality events belonging to a same monitoring item, to send an alarm notification to related emergency personnel.

Optionally, the first time interval includes at least a second-level time interval, and the second time interval is a time interval of at least a minute level.

FIG. 6 is a schematic diagram illustrating a structure of a large-scale alarm deployment device, according to one or more embodiments of this specification. The device includes: at least one processor; and a memory communicatively connected to the at least one processor, where the memory stores instructions that can be executed by the at least one processor, and the instructions are executed by the at least one processor, so that the at least one processor can: determine whether an indicator in a large-scale indicator set is a non-long-tail indicator or a long-tail indicator; for the non-long-tail indicator, schedule a task for traffic of the non-long-tail indicator by using a first time interval, and perform alarm calculation by executing the task; and for the long-tail indicator, perform aggregation processing on traffic of the long-tail indicator, schedule a task for correspondingly obtained aggregated data by using a second time interval longer than the first time interval, and perform alarm calculation by executing the task.

Based on the same idea, one or more embodiments of this specification further provide a non-volatile computer storage medium. The non-volatile computer storage medium stores computer executable instructions, and the computer executable instructions are set as follows: determining whether an indicator in a large-scale indicator set is a non-long-tail indicator or a long-tail indicator; for the non-long-tail indicator, scheduling a task for traffic of the non-long-tail indicator by using a first time interval, and performing alarm calculation by executing the task; for the long-tail indicator, performing aggregation processing on traffic of the long-tail indicator, scheduling a task for correspondingly obtained aggregated data by using a second time interval longer than the first time interval, and performing alarm calculation by executing the task.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written into a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using the computer-readable program code, logic programming can be performed on method steps to allow the controller to implement the same function in forms of the logic gate, the switch, the application-specific integrated circuit, the programmable logic controller, and the built-in microcontroller. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The system, apparatus, module, or unit illustrated in the above-mentioned embodiments can be implemented by using a computer chip or an entity, or can be implemented by using a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or any combination of these devices.

For ease of description, the above-mentioned apparatus is described by dividing functions into various units. Certainly, when this specification is implemented, functions of the units can be implemented in one or more pieces of software and/or hardware.

A person skilled in the art should understand that embodiments of this specification can be provided as methods, systems, or computer program products. Therefore, the embodiments of this specification can use a form of hardware only embodiments, software only embodiments, or embodiments with a combination of software and hardware. Moreover, this specification can use a form of a computer program product that is implemented on one or more computer-usable storage media (including but not limited to a disk memory, a compact disc read-only memory (CD-ROM), an optical memory, etc.) that include computer-usable program code.

This specification is described with reference to the flowcharts and/or block diagrams of the method, the device (system), and the computer program product based on the embodiments of this specification. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a special-purpose computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the block diagrams.

These computer program instructions can be stored in a computer-readable memory that can instruct the computer or the another programmable data processing device to work in a specific way, so the instructions stored in the computer-readable memory generate an artifact that includes an instruction apparatus. The instruction apparatus implements a specific function in one or more processes in the flowcharts and/or in one or more blocks in the block diagrams.

These computer program instructions can be loaded onto the computer or the another programmable data processing device, so that a series of operation steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more central processing units (CPU), input/output interfaces, network interfaces, and memories.

The memory may include a non-persistent memory, a random access memory (RAM), a non-volatile memory, and/or another form in a computer-readable medium, for example, a read-only memory (ROM) or a flash memory (flash RAM). The memory is an example of the computer-readable medium.

The computer-readable medium includes permanent and non-permanent, removable and non-removable media, and can store information by using any method or technology. The information can be a computer-readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in this specification, the computer-readable medium does not include a transitory computer-readable medium, for example, a modulated data signal and carrier.

It is worthwhile to further note that the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product, or device that includes the element.

This specification can be described in the general context of computer-executable instructions executed by a computer, for example, a program module. Generally, the program module includes a routine, a program, an object, a component, a data structure, etc. executing a specific task or implements a specific abstract data type. This specification can also be practiced in distributed computing environments. In the distributed computing environments, tasks are performed by remote processing devices that are connected through a communications network. In the distributed computing environments, the program module can be located in both local and remote computer storage media including storage devices.

Embodiments of this specification are described in a progressive way. For same or similar parts of the embodiments, mutual references can be made to the embodiments. Each embodiment focuses on a difference from other embodiments. In particular, the apparatus embodiments, the device embodiments, and the non-volatile computer storage medium embodiments are basically similar to the method embodiments, and therefore are described briefly. For related parts, references can be made to related descriptions of the method embodiments.

Specific embodiments of this specification are described above. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing is feasible or can be advantageous.

The above-mentioned descriptions are merely one or more embodiments of this specification and are not intended for limiting this specification. A person skilled in the art knows that one or more embodiments of this specification can have various modifications and changes. Any modification, equivalent replacement, improvement, etc. made within the spirit and principle of one or more embodiments of this specification shall fall within the scope of the claims of this specification.

what is claimed is:

1. A computer-implemented method, comprising:
determining whether a first indicator in a large-scale indicator set is a non-long-tail indicator or a long-tail indicator;
in response to determining that the first indicator is the non-long-tail indicator,
scheduling a first task for traffic data of the non-long-tail indicator by using a first time interval; and
performing alarm calculation by executing the first task;
determining whether a second indicator in the large-scale indicator set is the non-long-tail indicator or the long-tail indicator;
in response to determining that the second indicator is the long-tail indicator,
performing aggregation processing on traffic data of the long-tail indicator to obtain aggregated data;
scheduling a second task for the aggregated data by using a second time interval longer than the first time interval; and
performing alarm calculation by executing the second task.

2. The computer-implemented method according to claim 1, wherein an indicator in the large-scale indicator set indicates a merchant, the non-long-tail indicator indicates a non-long-tail merchant, the long-tail indicator indicates a long-tail merchant, and traffic data of a merchant comprises transaction service data of the merchant.

3. The computer-implemented method according to claim 2, wherein in response to determining that the second indicator is the long-tail indicator, performing aggregation processing on traffic data of the long-tail indicator to obtain aggregated data; scheduling a second task for the aggregated data by using a second time interval longer than the first time interval; and performing alarm calculation by executing the second task comprises:
determining second time intervals of a plurality of different levels that are longer than the first time interval;
for a current long-tail merchant or a current moment, determining, as a dynamic time interval, a second time interval in the second time intervals of the plurality of different levels to which the current long-tail merchant or the current moment corresponds; and
performing aggregation processing on transaction service data of one or more of the current long-tail merchant or a long-tail merchant associated with the current long-tail merchant by using the dynamic time interval to obtain the aggregated data, and scheduling the second task for the aggregated data.

4. The computer-implemented method according to claim 3, wherein the performing alarm calculation comprises:
determining whether the dynamic time interval is longer than a threshold; and
in response to determining that the dynamic time interval is longer than the threshold and that one or more of an industry feature or historical data of corresponding transaction service data are obtainable, triggering an intelligent algorithm detection process based on the one or more of the industry feature or the historical data to perform the alarm calculation; or
in response to determining that the dynamic time interval is not longer than the threshold, triggering a rule threshold detection process to perform the alarm calculation.

5. The computer-implemented method according to claim 2, wherein:
the performing aggregation processing on traffic data of the long-tail indicator comprises:
performing aggregation processing on transaction service data of the long-tail merchant through offline archiving; and
the scheduling a first task for traffic data of the non-long-tail indicator comprises:
performing online aggregation processing on transaction service data of the non-long-tail merchant to perform task scheduling.

6. The computer-implemented method according to claim 2, further comprising:
generating and maintaining a merchant class dimension table, and dynamically updating a merchant class in the merchant class dimension table and a time interval that corresponds to the merchant class and that is used for task scheduling, wherein the merchant class reflects a time interval currently corresponding to a corresponding merchant; and
scheduling a task comprises:
performing aggregation processing on transaction service data of a current corresponding merchant by using the time interval, and storing the aggregated data; and
obtaining, through query, the aggregated data according to the time interval based on an aggregation moment corresponding to the aggregation processing, and performing task scheduling accordingly.

7. The computer-implemented method according to claim 2, wherein determining that an indicator in the large-scale indicator set is a non-long-tail indicator comprises:
determining at least two types of non-long-tail merchants obtained through classification based on different high-frequency degrees of transactions, wherein first time intervals corresponding to the non-long-tail merchants are negatively correlated with the different high-frequency degrees of transactions; and
determining a type in the at least two types that a merchant in the large-scale indicator set belongs to; and
performing task scheduling by using a first time interval corresponding to the type.

8. The computer-implemented method according to claim 2, wherein the performing alarm calculation comprises:
detecting whether the transaction service data are abnormal based on a specified monitoring item;
in response to detecting that the transaction service data are abnormal based on the specified monitoring item, generating a corresponding abnormality event; and
performing alarm combination on a plurality of abnormality events belonging to a same monitoring item to send an alarm notification to related emergency personnel.

9. A non-transitory, computer-readable medium storing one or more instructions executable by a computer system to perform operations comprising:
determining whether a first indicator in a large-scale indicator set is a non-long-tail indicator or a long-tail indicator;
in response to determining that the first indicator is the non-long-tail indicator,
scheduling a first task for traffic data of the non-long-tail indicator by using a first time interval; and
performing alarm calculation by executing the first task;
determining whether a second indicator in the large-scale indicator set is the non-long-tail indicator or the long-tail indicator;
in response to determining that the second indicator is the long-tail indicator,
performing aggregation processing on traffic data of the long-tail indicator to obtain aggregated data;
scheduling a second task for the aggregated data by using a second time interval longer than the first time interval; and
performing alarm calculation by executing the second task.

10. The non-transitory, computer-readable medium of claim 9, wherein an indicator in the large-scale indicator set indicates a merchant, the non-long-tail indicator indicates a non-long-tail merchant, the long-tail indicator indicates a long-tail merchant, and traffic data of a merchant comprises transaction service data of the merchant.

11. The non-transitory, computer-readable medium of claim 10, wherein in response to determining that the second indicator is the long-tail indicator, performing aggregation processing on traffic data of the long-tail indicator to obtain aggregated data; scheduling a second task for the aggregated data by using a second time interval longer than the first time interval; and performing alarm calculation by executing the second task comprises:
determining second time intervals of a plurality of different levels that are longer than the first time interval;
for a current long-tail merchant or a current moment, determining, as a dynamic time interval, a second time interval in the second time intervals of the plurality of different levels to which the current long-tail merchant or the current moment corresponds; and
performing aggregation processing on transaction service data of one or more of the current long-tail merchant or a long-tail merchant associated with the current long-tail merchant by using the dynamic time interval to obtain the aggregated data, and scheduling the second task for the aggregated data.

12. The non-transitory, computer-readable medium of claim 11, wherein the performing alarm calculation comprises:
determining whether the dynamic time interval is longer than a threshold; and
in response to determining that the dynamic time interval is longer than the threshold and that one or more of an industry feature or historical data of corresponding transaction service data are obtainable, triggering an intelligent algorithm detection process based on the one or more of the industry feature or the historical data to perform the alarm calculation; or
in response to determining that the dynamic time interval is not longer than the threshold, triggering a rule threshold detection process to perform the alarm calculation.

13. The non-transitory, computer-readable medium of claim 10, wherein:
the performing aggregation processing on traffic data of the long-tail indicator comprises:
performing aggregation processing on transaction service data of the long-tail merchant through offline archiving; and
the scheduling a first task for traffic data of the non-long-tail indicator comprises:
performing online aggregation processing on transaction service data of the non-long-tail merchant to perform task scheduling.

14. The non-transitory, computer-readable medium of claim 10, wherein the operations further comprise:
generating and maintaining a merchant class dimension table, and dynamically updating a merchant class in the merchant class dimension table and a time interval that corresponds to the merchant class and that is used for task scheduling, wherein the merchant class reflects a time interval currently corresponding to a corresponding merchant; and
scheduling a task comprises:
performing aggregation processing on transaction service data of a current corresponding merchant by using the time interval, and storing the aggregated data; and
obtaining, through query, the aggregated data according to the time interval based on an aggregation moment corresponding to the aggregation processing, and performing task scheduling accordingly.

15. The non-transitory, computer-readable medium of claim 10, wherein determining that an indicator in the large-scale indicator set is a non-long-tail indicator comprises:
determining at least two types of non-long-tail merchants obtained through classification based on different high-frequency degrees of transactions, wherein first time intervals corresponding to the non-long-tail merchants are negatively correlated with the different high-frequency degrees of transactions; and
determining a type in the at least two types that a merchant in the large-scale indicator set belongs to; and
performing task scheduling by using a first time interval corresponding to the type.

16. The non-transitory, computer-readable medium of claim 10, wherein the performing alarm calculation comprises:
detecting whether the transaction service data are abnormal based on a specified monitoring item;
in response to detecting that the transaction service data are abnormal based on the specified monitoring item, generating a corresponding abnormality event; and
performing alarm combination on a plurality of abnormality events belonging to a same monitoring item to send an alarm notification to related emergency personnel.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining whether a first indicator in a large-scale indicator set is a non-long-tail indicator or a long-tail indicator;
in response to determining that the first indicator is the non-long-tail indicator,
scheduling a first task for traffic data of the non-long-tail indicator by using a first time interval; and
performing alarm calculation by executing the first task;
determining whether a second indicator in the large-scale indicator set is the non-long-tail indicator or the long-tail indicator;
in response to determining that the second indicator is the long-tail indicator,
performing aggregation processing on traffic data of the long-tail indicator to obtain aggregated data;
scheduling a second task for the aggregated data by using a second time interval longer than the first time interval; and
performing alarm calculation by executing the second task.

18. The computer-implemented system of claim 17, wherein an indicator in the large-scale indicator set indicates a merchant, the non-long-tail indicator indicates a non-long-tail merchant, the long-tail indicator indicates a long-tail merchant, and traffic data of a merchant comprises transaction service data of the merchant.

19. The computer-implemented system of claim 18, wherein in response to determining that the second indicator is the long-tail indicator, performing aggregation processing on traffic data of the long-tail indicator to obtain aggregated data; scheduling a second task for the aggregated data by using a second time interval longer than the first time interval; and performing alarm calculation by executing the second task comprises:
determining second time intervals of a plurality of different levels that are longer than the first time interval;
for a current long-tail merchant or a current moment, determining, as a dynamic time interval, a second time interval in the second time intervals of the plurality of different levels to which the current long-tail merchant or the current moment corresponds; and
performing aggregation processing on transaction service data of one or more of the current long-tail merchant or a long-tail merchant associated with the current long-tail merchant by using the dynamic time interval to obtain the aggregated data, and scheduling the second task for the aggregated data.

20. The computer-implemented system of claim 18, wherein:
the performing aggregation processing on traffic data of the long-tail indicator comprises:
performing aggregation processing on transaction service data of the long-tail merchant through offline archiving; and
the scheduling a first task for traffic data of the non-long-tail indicator comprises:
performing online aggregation processing on transaction service data of the non-long-tail merchant to perform task scheduling.
